(19) United States
(12) Patent Application Publication
(10) Pub. No.: US 2007/0031635 A1
(43) Pub. Date: Feb. 8, 2007

(54) Decorative ornament

(76) Inventor: Heather A. Shepardson, Denver, CO (US)

Correspondence Address: MARTIN & HENSON, P.C., 9250 W 5TH AVENUE, SUITE 200, LAKEWOOD, CO, 80226, US

(21) Appl. No.: 11/283,023

(22) Filed: Nov. 17, 2005

Related U.S. Application Data
(63) Continuation-in-part of application No. 11/161,470, filed on Aug. 4, 2005.

(51) Int. Cl. B32B 3/06

(52) U.S. Cl. 428/99; 428/15; 428/7

(57) ABSTRACT

An ornament adapted to mount to a support as part of a decorative display includes a decorative body, a bendable mounting element with a proximal end portion secured to the body, and a fastener secured to the distal end portion of the mounting element. The mounting element optionally may be both flexible and resilient, such as a spring or a plastic post, or may optionally be formed of a malleable material. The fastener may be longitudinally aligned with or perpendicular to an axis passing through the center of the decorative body. The fastener may be a pincher clip. The decorative body may take on various decorative images, including but not limited to Christmas ornaments.

### FIELD OF THE INVENTION

The present invention generally relates to decorating a home, office, etc., for example, to create a festive atmosphere.

### BACKGROUND

Throughout history, humans have sought to enhance their surroundings by the use of decorative items. Such items have included such diverse elements as wall paintings, tiles, tapestries and two-dimensional art, to name a few. In many instances, such decorative elements become a relatively permanent part of the environment in which they are placed, remaining on display for years on end. In contrast to these long-term decorations, some decorative items are intended to be of a more transient nature. One example is the use of fresh cut flowers that have a display life of only a few days.

In addition to these types of decorations, it is also known to create decorations for special events or seasons. Often, such events or seasons are correlated to a specific event, holiday or commemorative anniversary. Often, such holidays or seasons have an established theme associated therewith. In the United States, for example, the holidays that are key for decorating are Valentine's Day, Easter, Fourth of July, Halloween, Thanksgiving, and Christmas. Additionally, as the trend for decorating geared to a particular theme expands, other events such as New Year's Eve, St. Patrick's Day, Memorial Day and Labor Day have become decorating events. Other decorative themes such as March Madness (basketball), Super Bowl Day (football) and the like give rise to decorative themes. Seasonal themes may include the advent of spring, fall harvest, and the like.

One common decorative display centers around the use of a wreath or wreath like item that can be hung from a wall or a door. Such wreathes may be made of plants such as sprigs of evergreens, boughs, vines or flowers, either natural or artificial. Alternatively, it is known to make such wreathes out of a cloth covered polystyrene plastic, other plastic or wooden materials and the like. Such wreathes may be decorated with thematic items such as pinecones, ornaments, ribbons, bows, etc.

The traditional ornament is in the form of a decorative body that is formed in an image or that is painted or printed in a decorative theme or that carries a message correlated to the event being celebrated. A mount is provided on the decorative body, typically in the form of a small loop of wire to complete the ornament. This ornament is then suspended from the support by means of a hooked piece of wire, string, or the like.

The traditional ornament has some disadvantages. On the one hand, where the ornament is suspended by a hook, it is common for the ornament to become dislodged from the support. This can occur when children, who are naturally fascinated by the decorative display, touch or play with the ornament. Pets are also known to dislodge such ornaments, and they can be dislodged simply from accidental contact with the ornament. Securing the ornament with string reduces such likelihood of dislodgement; however, the use of string is more difficult and inconvenient. Further, such ornaments cannot be mounted so as to project forwardly from a vertically oriented display (such as a wreath) since they must be suspended by gravity.

Accordingly, there is a need for ornaments that are more versatile in their ability to mount to decorative displays. There is a further need for ornaments that are simple and easy to attach to a support as part of a decorative display. A still further need is to provide an ornament that resists dislodgement. Such goals have been the impetus of the present invention.

### SUMMARY

It is one aspect of the exemplary embodiments to provide a new and useful ornament that is adapted to mount to a support as part of a decorative display.

It is also an aspect of the exemplary embodiments to provide an ornament that reduces the likelihood of its dislodgement from a support.

It is another aspect of some of the exemplary embodiments of the present invention to provide an ornament that may be mounted to extend forwardly from a vertically disposed support.

It is a further aspect of an exemplary embodiment to allow an ornament to be vertically suspended from a support.

It is a further aspect of the exemplary embodiments to provide a more convenient attachment for securing an ornament to a support.

According to the exemplary embodiments of the present invention, an ornament is adapted to be mounted to a support as part of a decorative display. Broadly, this ornament includes a decorative body having a center and an outer surface. A bendable mounting element includes a proximal end portion secured to the decorative body and which projects therefrom to terminate in a distal end portion. A fastener is then disposed on the distal end portion of the mounting element.

As noted, the mounting element is bendable. To this end, the exemplary embodiments disclose both flexible and resilient elements, such as coil springs, plastic rods and plastic strips, and malleable elements, such as a length of malleable wire or plastic. Other such fasteners may include strips of spring steel or the like, although any flexible and resilient mounting element is contemplated.

Likewise, the exemplary embodiments disclose different types of fasteners that may be secured to the decorative body by the flexible and resilient mounting element. Such fasteners include pincher clips of any type, including alligator clips, additionally, fasteners, such as pins, screws, etc. are contemplated.

The decorative body can take virtually any form, as desired. For example, the decorative body may include solid geometric figures (such as cubes, spheres, or any other polyhedrons whether regular or irregular), shells of three dimensional figures (such as hollow cubes, hollow spheres, hollow polyhedrons (regular or irregular)), or any other three dimensional image including, for example, figures of people (real and imaginary), animals (real and imaginary), fruit, berries, dried vegetables, Christmas ornaments, Easter eggs, Easter baskets, artificial flowers, artificial fruits, artificial vegetables, artificial grains, dried fruits, dried vegetables, wine bottles, bats, spiders, ghosts, witches, skulls and miniature sports equipment. Further, the decorative body may also be a relative two-dimensional geometric construct having as minimal thickness as practical.

In the exemplary embodiments, the fastener has a longitudinal axis. The fastener is disclosed, but it is not required that the fastener be oriented such that the longitudinal axis thereof is generally aligned with the center of the decorative body. Moreover, the fastener can have its longitudinal axis oriented so that it is generally perpendicular to the surface of the decorative body adjacent to the proximal end portion of the mounting member. The fastener can extend from a rearward surface of the decorative body, from the flat surface of the decorative body or from any other surface portion.

These and other aspects of the exemplary embodiments of the present invention will become more readily appreciated and understood from a consideration of the following detailed description when taken together with the accompanying drawings, in which:

### BRIEF DESCRIPTION OF THE DRAWINGS

FIG. 1 is a side view in elevation of an ornament according to a first exemplary embodiment of the present invention shown mounted to a support in the form of a decorative wreath;

FIG. 2 is a perspective view of the decorative ornament of FIG. 1;

FIG. 3 is a cross-sectional view taken about lines 3-3 of FIG. 2;

FIG. 4 is an exploded perspective view of the ornament of FIGS. 2 and 3;

FIG. 5 is an exploded perspective view of a second exemplary embodiment of the present invention;

FIGS. 6(a) and 6(b) are diagrammatic exploded side views in partial cross-section of the ornaments of FIGS. 4 and 5, respectively (without the decorative features thereon), illustrating the alignment of a fastener with the center of the geometrical body;

FIG. 7 is a side view in elevation of a third exemplary embodiment of the present invention;

FIG. 8 is a side view in partial cross-section showing a fourth exemplary embodiment of the present invention;

FIG. 9 is a side view in cross-section showing a fifth exemplary embodiment of the present invention;

FIG. 10 is a side view in elevation showing a sixth exemplary embodiment of the present invention;

FIG. 11 is a side view in cross-section showing a seventh exemplary embodiment of the present invention; and

FIG. 12 is a side view in cross-section showing an eighth exemplary embodiment of the present invention.

### DETAILED DESCRIPTION OF THE EXEMPLARY EMBODIMENTS

The present invention broadly relates to decorative items that may be used for any event, including holidays, theme parties, etc. More particularly, the exemplary embodiments disclosed herein relate to a decorative ornament that is adapted to be secured to a support such as a Christmas tree, Christmas wreath, garland, plant arrangement, without limitation. As such, the exemplary embodiments disclose an ornament adapted to mount to a support as part of a decorative display. For purposes herein, the term “ornament” is to be broadly construed to include any type of item that may be secured to a support for purposes of providing a decoration and should not be limited to any specific concept, such as a Christmas tree ornament.

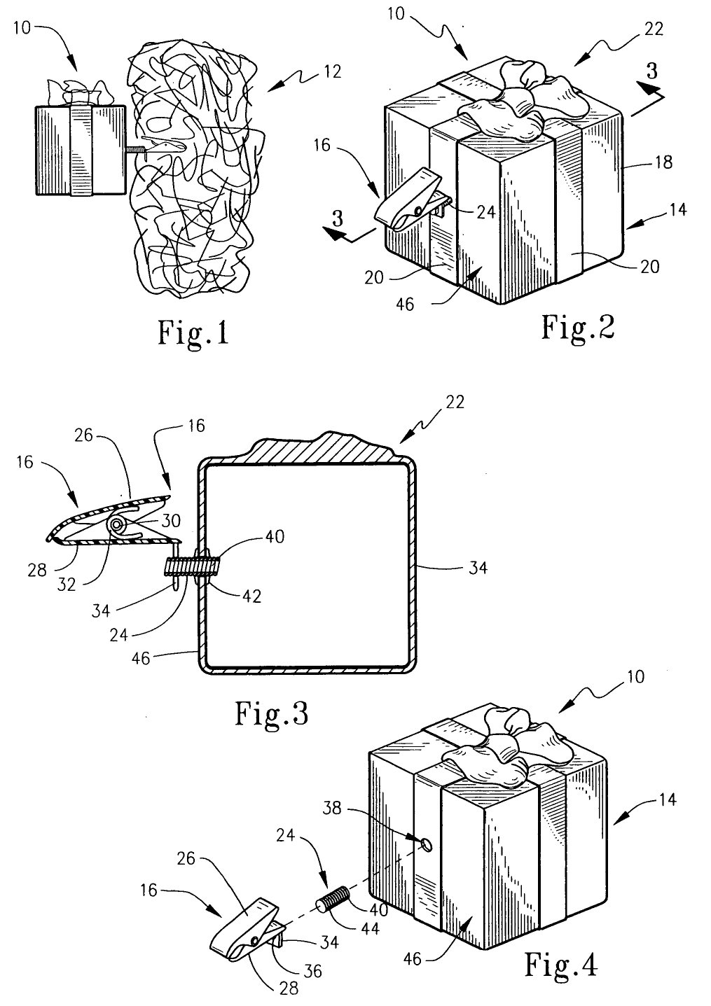

With reference, then, to FIGS. 1 and 2, a decorative ornament 10 according to the first exemplary embodiment of the present invention is illustrated as being mounted to a support in the form of a portion of Christmas wreath 12 as is shown in FIG. 1, ornament 10 includes a decorative body 14 having a pincher clip 16 secured thereto and extending from an outer surface. In FIG. 2, it is shown that ornament 10 simulates a wrapped Christmas package having an outer wrapping 18, sections of ribbon 20 and a bow 22. Decorative body 14 may be formed of any suitable material including, but not limited to, glass, ceramics, plastic, wood, etc. A fastener in the form of a pincher clip 16 is secured to decorative body 14 by means of a bendable element, here in the form of a flexible and resilient coil spring 24.

With reference especially to FIGS. 3 and 4, it may be seen that pincher clip 16 may be of the type known as a “alligator clip” that includes a pair of jaws 26 and 28 that are pivotally secured to one another along a pivot axle 30 and are biased into a clamped state by means of a spring 32 as is known in the art. Lower jaw 28 is provided with a downwardly depending flange 34 that is generally perpendicular to the flat base portion of lower jaw 28. Flange 34 is provided with an opening 36 adapted to mount onto coil spring 24.

Similarly, decorative body 14 has an opening 38 to mount onto coil spring 24. To this end, coil spring 24 has a proximal end portion 40 that extends through opening 38 and is secured therein by a suitable adhesive 42. The ordinarily skilled artisan, however, should recognize that there are many different ways to secure the end portion 40 of coil spring 44 to decorative body 14 so that the particular attachment technique may vary, as desired. In any event, distal end portion 44 of coil spring 24 is secured to pincher clip 16, again in any convenient manner. Here, coil spring 24 and opening 36 are selected so that clip 16 may simply screw onto distal end portion 44 of spring 24 without the need for any specific adhesive, screw or other attachment.

From the foregoing, it should be recognized that ornament 10, as constructed according to the exemplary embodiment is adapted to mount onto a support, especially a vertically oriented support, so that it projects forwardly thereof, as is illustrated in FIG. 1. To this end, the fastener, such as pincher clip 16 projects outwardly from a back surface 46 relative to the decorative design depicted on the decorative body 14. Moreover, by mounting pincher clip 16 at the end of a flexible and resilient mounting element, such as coil spring 24, the likelihood of accidental dislodgement of decorative ornament 10 from the support 12 is reduced.

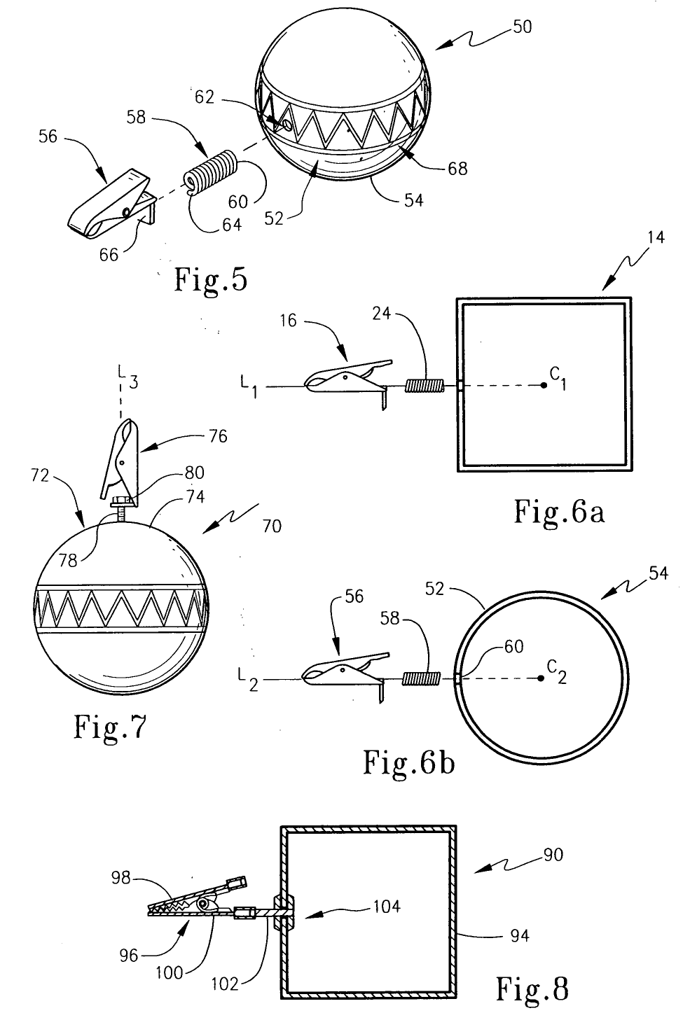

While ornament 10 is described to depict a wrapped Christmas gift, the subject matter of the decorative body may take on virtually limitless configurations or designs. Thus, for example, a second exemplary embodiment of the present invention is illustrated in FIG. 5 where it may be seen that ornament 50 includes a spherical decorative body 52 having an outer surface 54. A fastener, again in the form of pincher clip 56 is secured, in any convenient manner, to decorative body 52 by means of a flexible and resilient mounting element, again in the form of coil spring 58. Coil spring 58 has a proximal end portion 60 adapted to mount into opening 62 formed in decorative body 52 and has a distal end portion 64 adapted to attach to flange 66 of clip 56, as discussed above with reference to spring 24 and pincher clip 16. Here, however, a decorative body 52 is shown to be spherical in configuration having exterior decorations in the form of decorative band 68 so that clip 56 projects rearwardly of decorative body 52 away from outer surface 54.

With reference now to FIGS. 6(a) and 6(b) it may be seen that clips 16 and 56 each may have a longitudinal axis, such as axis “L₁” and “L₂”, respectively. Decorative bodies 14 and 52 are here illustrated without any decoration, thereon. Each of these decorative bodies is a geometric shell and has a center, such as centers “C₁” and “C₂”. It is desirable in these embodiments that the longitudinal axis L₁, L₂ be generally aligned with centers C₁, C₂ so that the direction of the projection of the spring clip will somewhat line up with the center of the decorative body. Accordingly, springs 24 and 58, respectively, are generally aligned with the centers of C₁,C₂.

Further, and regardless of whether the longitudinal axis of the clip aligns with the center of the decorative body, the longitudinal axis of the clip is oriented so that it is generally perpendicular to the surface of the decorative body adjacent to the proximal end portion of the mounting member. Therefore, as is illustrated in FIG. 6(a), clip 16 has its longitudinal axis L₁ generally perpendicular to back surface 46 of the cubic geometry of decorative body 14. Likewise, as is illustrated in FIG. 6(b), longitudinal axis L₂ of clip 56 would be generally perpendicular to surface 54 at the portion of outer surface 54 that is adjacent opening 60 wherein the proximal end of spring 58 is mounted. With respect to the spherical body, this, of course, means that L₂ is generally perpendicular to a plane that is tangent to the spherical geometry of decorative body 54 at opening 60.

FIG. 7 illustrates a third exemplary embodiment of the present invention. Here, ornament 70 has a decorative body 72 having an outer surface 74. Decorative body 72 is illustrated to have the same appearance as decorative body 52. Clip 76 is again secured to decorative body 72 by means of a flexible and resilient mounting element again illustrated as a coil spring 78. Here, however, clip 76 has a flange 80 that projects oppositely of flanges 34 and 66 of clips 16 and 56, respectively. Moreover, clip 76 is oriented so that it projects outwardly from the top surface of decorative body 72. This configuration allows an ornament, such as ornament 70, to be mounted to a support so as to be suspended downwardly therefrom. This embodiment is particularly useful for suspending an ornament 70, for example, from a Christmas tree.

FIG. 8 illustrates yet another embodiment of the present invention that is similar to ornament 10. Here, however, ornament 90 supports a pincher clip in the form of alligator clip 96 that has toothed jaws 98 and 100. Moreover, the flexible and resilient mounting element is different, here being in the form of a rod or strip 102 made of flexible, resilient plastic or metal. Clip 96 is mounted on the distal end of rod 102, and rod 102 has its proximal end secured to decorative body 94, for example by a rivet like structure 104 of the plastic material forming rod 102.

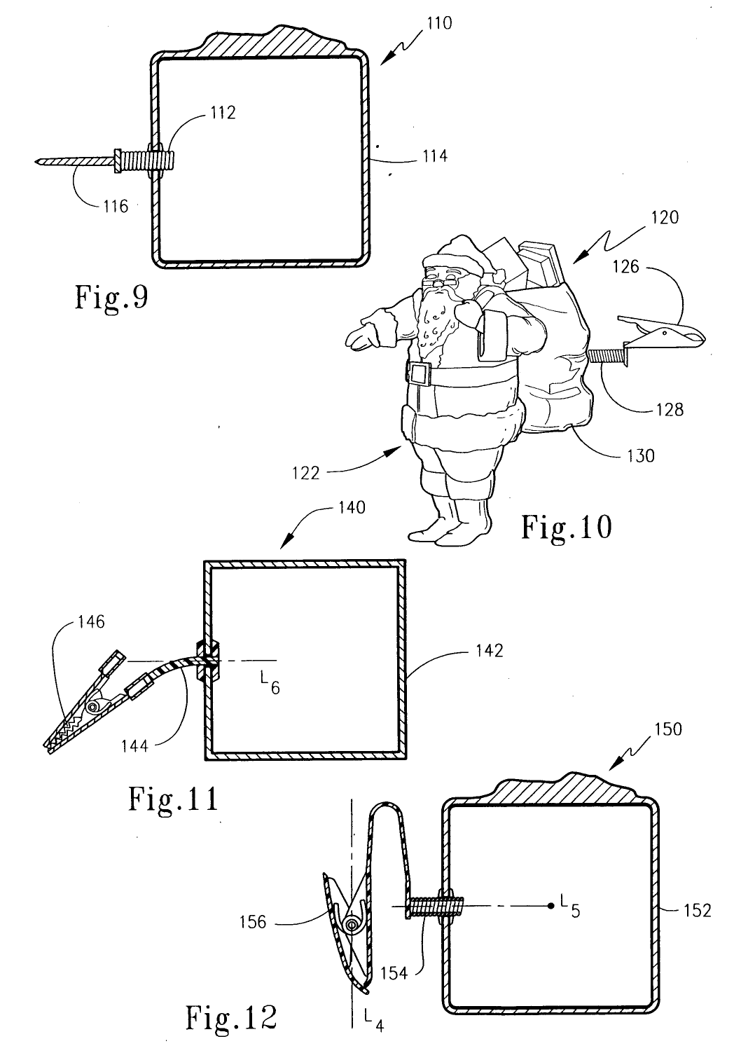

FIG. 9 illustrates yet another embodiment of the present invention that is similar, in most aspects, to the first embodiment. FIG. 9 is provided to illustrate that the fastener disposed on the distal end of the mounting element is not restricted to a pincher clip. Here, ornament 110 is similar to ornament 10 except that there has been a change in this fastener. More specifically, as is shown in FIG. 9, the flexible and resilient mounting element in the form of spring 112 has a proximal end portion secured to decorative body 114. A fastener, here in the form of a small nail 116 is mounted to the distal end portion of spring 112. Nail 116 facilitates mounting ornament 110, for example, to a Styrofoam or of a “cushion-like” support.

FIG. 10 illustrates another embodiment of a decorative ornament 120 here illustrated to be in the appearance of a Santa Claus. Accordingly, decorative body 122 sports the appearance of Santa Claus while pincher clip 126 is mounted rearwardly by spring 128 so that it projects rearwardly from back surface 130 of the Santa Claus image.

FIG. 11 shows yet another embodiment of an ornament 140. Here, decorative body 142 is connected to pincher clip 146 by means of a malleable element 144. Malleable element 144 may take any suitable form, such as a length of bendable wire, plastic or other material. While this construction does not have the advantages of a flexible and resilient element, it has a different advantage in that it permits adjustable positioning of the ornament 140 relative to the support member after it has been attached thereto. Pincher clip 146 is shown positioned at an angle relative to axis “L₆”. Accordingly, malleable element 144 is bent away from axis L₆.

Finally, FIG. 12 shows an exemplary embodiment wherein the orientation of the fastener has been changed. More particularly, ornament 150 includes a pincher clip 156 that is secured to decorative body 152 by means of a coil spring 154. Here, however, pincher clip 156 has a longitudinal axis “L₄” that is oriented transversely to the axis “L₅” containing the center of the decorative body 152. While this transverse orientation is depicted as substantially perpendicular, it should be understood that “transversely” can mean any oblique angle between about forty-five and about one hundred thirty-five degrees.

From the foregoing, it should be appreciated that the appearance of the decorative body is, indeed, virtually limitless. Accordingly, and without limitation, the decorative body may be selected from a group consisting of: solid geometric figures (such as cubes, spheres, or any other polyhedrons whether regular or irregular) shells of three dimensional figures (such as hollow cubes, hollow spheres, hollow polyhedrons (regular or irregular)), or any other three dimensional image that may include figures of people (real and imaginary), animals (real and imaginary), fruit, berries, dried vegetables, Christmas ornaments, Easter eggs, Easter baskets, artificial flowers, artificial fruits, artificial vegetables, artificial grains, dried fruits, dried vegetables, wine bottles, bats, spiders, ghosts, witches, skulls and miniature sports equipment. Further, the decorative body may also be a relative two-dimensional geometric construct having as minimal thickness as practical. Again, the theme of the image is almost limitless and can certainly include any image listed above. This means that the decorative body would have a flat, plate-like configuration.

In addition, any suitable fastener, as described above, can be substituted in any embodiment. Likewise, any suitable bendable element whether flexible and resilient or malleable, can be substituted in any embodiment. For example, in addition to coil springs and plastic posts or strips, it is possible that a leaf spring be used. Indeed, any suitable flexible and resilient material, whether now known or hereinafter developed could be employed. The fastener, in addition to pincher clips and nails, could be pins, screws or the like, as should be recognized by the skilled artisan.

Accordingly, the present invention has been described with some degree of particularity directed to the exemplary embodiments of the present invention. It should be appreciated, though, that the modifications or changes may be made to the exemplary embodiments of the present invention without departing from the inventive concepts contained herein.

I claim:

1. An ornament adapted to mount to a support as part of a decorative display, comprising:
(A) a decorative body having a center and an outer surface;
(B) a bendable mounting element including a proximal end portion secured to said decorative body and projecting therefrom to terminate in a distal end portion; and
(C) a fastener disposed on the distal end portion of said mounting element.

2. An ornament according to claim 1 wherein said mounting element is flexible and resilient.

3. An ornament according to claim 2 wherein said mounting element is a spring.

4. An ornament according to claim 3 wherein said spring is a coil spring.

5. An ornament according to claim 1 wherein said mounting element is a post formed of a plastic material

6. An ornament according to claim 1 wherein said mounting element is malleable.

7. An ornament according to claim 1 wherein said fastener is selected from a group consisting of: pincer clips, pins, nails, and screws.

8. An ornament according to claim 1 wherein said fastener has a longitudinal axis, said fastener being oriented such that the longitudinal axis thereof is generally aligned with the center of the decorative body.

9. An ornament according to claim 1 wherein said fastener has a longitudinal axis, said fastener being oriented such that the longitudinal axis thereof is generally perpendicular to the surface of said decorative body adjacent to the proximal end portion of said mounting member.

10. An ornament according to claim 1 wherein said mounting element has a longitudinal axis, said fastener being oriented such that the longitudinal axis is transverse to an axis passing through the center of the decorative body.

11. An ornament according to claim 1 wherein said decorative body is selected from a group consisting of: three dimensional figures, three dimensional images, two dimensional figures and two dimensional images.

12. An ornament according to claim 1 wherein said decorative body is selected from a group consisting of: Christmas ornaments, Easter eggs, Easter baskets, flags, stars, hearts, clover, rabbits, baby chicks, baby ducks, artificial flowers, artificial fruits, artificial vegetables, artificial grains, dried fruits, dried vegetables, wine bottles, bats, spiders, ghosts, witches, skulls and miniature sports equipment.

13. An ornament adapted to mount to a support as part of a decorative display, comprising:
(A) a decorative body having a center and an outer surface;
(B) a coil spring defining a flexible and resilient mounting element including a proximal end portion secured to said decorative body and projecting therefrom to terminate in a distal end portion; and
(C) a pincer clip having a longitudinal axis, said pincer clip being disposed on the distal end portion of said mounting element and oriented such that the longitudinal axis thereof is generally aligned with the center of the decorative body.

14. An ornament according to claim 13 wherein the longitudinal axis of said pincer clip is generally perpendicular to the surface of said decorative body adjacent to the proximal end portion of said mounting member.

15. An ornament according to claim 13 wherein said pincer clip is an alligator-type clip.

16. An ornament according to claim 13 wherein said decorative body is selected from a group consisting of: geometric solids, geometric solid shells, and figures.

17. An ornament according to claim 13 wherein said decorative body is selected from a group consisting of: Christmas ornaments, Easter eggs, Easter baskets, flags, stars, hearts, clover, rabbits, baby chicks, baby ducks, artificial flowers, artificial fruits, artificial vegetables, artificial grains, dried fruits, dried vegetables, wine bottles, bats, spiders, ghosts, witches, skulls and miniature sports equipment.
